(19) United States
(12) Patent Application Publication
(10) Pub. No.: US 2026/0178287 A1
(43) Pub. Date: Jun. 25, 2026

(54) Method and Device for Checking an Algorithm Integrity for a Generated Program Code for Computing a Neural Network on a Hardware Environment

(71) Applicant: Robert Bosch GmbH, Stuttgart (DE)

(72) Inventors: Sebastian Boblest, Duernau (DE); Benjamin Wagner, Friedrichshafen (DE); Duy Khoi Vo, Waiblingen (DE); Leif Sulaiman, Lund (SE); Markus Lochmann, Reutlingen (DE); Ulrik Hjort, Malmö (SE)

(21) Appl. No.: 19/422,841

(22) Filed: Dec. 17, 2025

(30) Foreign Application Priority Data
Dec. 20, 2024 (DE) 10 2024 212 257.2

(51) Int. Cl. G06F 8/35

(52) U.S. Cl. CPC G06F 8/35

(57) ABSTRACT

A computer-implemented method for operating a code generator to create a program code for computing a neural network in a hardware environment is disclosed. The method includes (i) providing a defined neural network, (ii) identifying at least one tiling group, (iii) creating a tiling code segment for computing the layers of the at least one tiling group using tiling, (iv) creating a program code for computing the defined neural network in the hardware environment, wherein the code segment created for computing the tiling group is implemented in the program code, and (v) implementing the program code in the hardware environment.

This application claims priority under 35 U.S.C. § 119 to patent application no. DE 10 2024 212 257.2, filed on Dec. 20, 2024 in Germany, the disclosure of which is incorporated herein by reference in its entirety.

The disclosure relates to the creation of a program code on a hardware environment, such as that occurring as microcontroller-controlled control devices and the like. The disclosure further relates to methods for computing layers of neural networks with a tiling implemented in the created program code.

### BACKGROUND

Neural networks have become a prevalent class of algorithms in both science and industry over the past ten years. A key point in their deployment in production is to ensure that these algorithms work properly when installed on the hardware environment for which they were generated. This is mandatory for use in safety-critical applications such as automotive, medical equipment, or aerospace applications.

Certain hardware environments, such as microcontrollers in control devices, require the creation of an adjusted executable program code to take into account the characteristics and limitations of the specific hardware environment. In particular, the available memory size of the working memory that can be directly accessed by the microcontroller or acceleration hardware may be limited, or memory shift or copy operations from a data memory, such as flash or external memory, to the working memory may be particularly complex due to hardware constraints.

The calculation steps for computing corresponding network layers of neural networks can require considerable memory, since for each calculation step an input data block, a model parameter block, and an output data block must be retrieved and stored in the working memory in a form that can be used by the microcontroller.

During memory planning, existing code generators determine in which region of the working memory the data blocks required for each calculation step are stored. During memory planning, in addition to assigning the input data blocks, output data blocks, and, if necessary, the model parameters to memory spaces of the working memory, the data generated during the calculation in a calculation step is also assigned a corresponding memory space.

Conventional code generators for neural networks do not usually assume limited working memory and typically allocate distinct memory spaces for storing the input data blocks, network parameter blocks, and output data blocks for each of the successive calculation steps. Until now, it has therefore been common practice to distribute the model parameters freely in the available memory in order to minimize the total memory requirement. However, this procedure may still not be sufficient to optimally perform the calculations of the layers of the neural network with further limited memory.

It is the object of the present disclosure to provide an improved method for code generation for computing artificial neural networks on a hardware environment with limited memory, which in particular improves the calculations of certain layers of the neural network with limited memory.

### SUMMARY

This task is solved by the method for operating a code generator to create and implement a program code for computing a neural network in a hardware environment as described below, as well as by the code generator according to the description set forth below.

Further embodiments are specified in the description set forth below.

According to a first aspect, a computer-implemented method for operating a code generator to create a program code for computing a neural network in a hardware environment is provided, comprising the following steps:
providing a defined neural network;
identifying at least one tiling group;
creating a tiling code segment for computing the layers of the at least one tiling group using tiling;
creating a program code for computing the defined neural network in the hardware environment, wherein the code segment created for computing the tiling group is implemented in the program code;
implementing the program code in the hardware environment.

As part of code generation, a program code for computing a neural network is created using a code generator such as Embedded AI Coder. Here, a neural network is created as a program code that can be executed on a microprocessor, microcontroller, GPU, or dedicated neural network accelerator as a hardware environment. The program code is based on a defined neural network provided in a common definition description, such as an onnx file, a model stored in keras, a tensorflow-lite model, or an exported pytorch file. It may be formed in a higher programming language, such as in C, in a lower-level representation such as LLVM or inline assembly, or as a combination of such representations, such as C code, invoking pre-implemented library functions.

Convolutional networks (CNNs) are a key technology in the field of machine learning. Implementing CNNs on hardware environments with limited memory, such as microcontrollers, is difficult due to the high RAM demand of the convolution output tensors. For example, a convolution with a 128×128×3 image input, a kernel size of 3×3, a stride of 1, with “same” padding (Padding same) and 16 output channels, produces an output tensor size of 128 ×128×16. In int8 format, this requires 262144 bytes of memory.

In particular, when other algorithms on the system simultaneously require memory, the memory requirement may render implementation impossible, although the microcontroller is otherwise powerful enough, particularly in terms of computing power. A similar problem arises when the hardware environment uses an accelerator for calculations of neural networks as a co-processor that does not have sufficient memory for large convolutions.

In both cases, tiling may be employed to reduce the amount of memory required. Tiling is a technique in which a neural network is (in part) divided into smaller portions, which are then calculated sequentially. Depending on the structure of the neural network, this may dramatically reduce the need for memory.

The core of the above method for a code generator is to provide the tiling in a program code created in such a way that it can be adapted very flexibly to the characteristics of the hardware environment. Possible metrics may be: minimum memory requirement, reduction of memory requirement below a threshold value with as short an inference time as possible, or implementing a tiling so that the created program code can be executed with a hardware accelerator.

All connected operators/layers in the defined neural network that are to be tiled are referred to as the tiling group.

It may be provided that the at least one tiling group is formed with a number of serially consecutively computed layers, processes an input tensor and computes an output tensor in the layers, wherein each of the layers of the tiling group corresponds to one of the following operators: a convolution calculation, a pooling layer calculation, one of the element-wise operations: adding, subtracting, and multiplying, and one of the element-wise activation functions, such as ReLU and LeakyReLU.

The tiling factor tf determines how many tiling segments (sub-graphs) the input tensor is divided into. The tiling factor tf may be determined independently for each of multiple tiling groups. The tiling group contains tf copies of the original operators/layer functions, which may be grouped into tf sub-charts with tiling indices it € [0, tf-1].

Only certain layers of a neural network may be applied to tiling, namely those that do not require the full input tensor of the layer to generate an element of the output tensor. For example, fully-connected layers and LSTMs cannot be computed using tiling.

All layers that support tiling work with image-like data having a height, width, and channel dimension. The channel dimension cannot be computed using tiling because all channels are required simultaneously for calculating any output pixel except for depthwise convolution layers. However, tiling is possible in both the row and column directions, wherein only the tiling in the row direction is considered herein, since all data in a tiling input tensor is stored in contiguous memory in this way. This enables more efficient implementations for partitioning the input tensor into part input tensors for tiling segments and concatenating the resulting part output tensors of the tiling segments.

The proposed tiling algorithm inserts a MultiSlice operator for each part input tensor for a tiling group, and a concatenation operator for each part output tensor that is an output of a tiling group in the part applied with tiling of the neural network.

MultiSlice is an operator that relates only to tiling segments. It has no equivalent in Tensorflow or other deep learning frameworks. It resembles a combination of a slice and a split operation, and creates a part input tensor for each tiling segment from the original input tensor. However, due to the receptive field of the convolution layer, the individual slices of a MultiSlice operator may overlap. Convolution operations and deep convolution operations with a kernel size >1 require data from multiple input rows and columns to calculate a single output value. This is referred to as the receptive field of convolution.

When multiple convolutional layers with a kernel size >1 in a neural network are serially “stacked” in succession, the receptive field of the later layers will become larger. That is, ever larger areas of the input tensor of earlier (first calculated) layers affect the output of later layers.

When a neural network is tiled, the receptive field of the convolution operations results in the interim results of the individual tiling segments overlapping.

Increasing the receptive field in tiling segments may cause an additional complication. When a tensor is consumed by two operators, the receptive field of the two operators may be different, and therefore both operators might need different areas of the tensor to generate their part of the output tensor.

Element offsets may be provided. An element offset may be either an offset at the start of the particular part output tensor or an offset at the end of the particular part output tensor. If an offset is required at the beginning of the part input tensor, an offset must be introduced into the tensor argument in the function call of the corresponding layer implementation. In C, for example, this may be implemented using pointer arithmetic. If an offset is required at the end of the part input tensor, no change is required. The part input tensor is simply not used up to the last elements.

Larger tiling factors can increase the potential for memory savings, but can also increase the run time to calculate the layers. The additional run time is caused by the duplicate calculations required for the overlapping receptive fields of the tiling segments. If weight prefetching is used or on systems with a cache, the run time may also increase due to the repeated loading of the weights. For each copy of an original operator, weights must be reloaded during weight prefetching as the copies are executed with a plurality of layers between them in the tiling segment. Weights that are in the cache cannot be kept in the cache for the same reason in many cases between two copies of the same layer and then must also be loaded multiple times.

The method may further comprise the steps:
creating a number of tiling segments as copies of the code segments of the calculations of the layers in the at least one tiling group;
determining the part input tensors needed by the tiling segments but not generated by any of the layers in the tiling group and the part output tensors that are outputs of the tiling segments.

determining the lines for each part output tensor, wherein a respective start index and an end index are determined,
determining the lines for each part input tensor, wherein a respective start index and an end index are determined,
creating a code segment for a MultiSlice operator that divides the input tensor of the tiling group into part input tensors using the start indices and end indices and associates it with the respective tiling segment;
creating a code segment for a concatenation operator to combine the part output tensors to the output tensor to be calculated,
compiling the MultiSlice operator, the calculations of the layers for each of the tiling segments, and the concatenation operator to the code segment.

In particular, the lines of each part output tensor may be determined so that each line of the output tensor to be computed by the tiling group is computed in a tiling segment, no line of the part output tensor is computed in multiple tiling segments, and the lines of the output tensor to be computed by the tiling group are distributed as evenly as possible among the tiling segments.

Furthermore, the lines of the output tensor may be distributed among the part output tensors in equal parts, wherein excess lines are evenly distributed among some of the part output tensors.

It may be provided that a padding of the input tensor is considered for determining the rows for each partial input tensor.

Furthermore, it may be provided that a tiling group comprises only at least one layer, wherein the code segment is provided for execution in an accelerator hardware of the hardware environment, wherein a required tiling factor for the number of tiling segments is determined such that a working memory of the accelerator hardware is sufficient to compute the tiling segments.

### BRIEF DESCRIPTION OF THE DRAWINGS

Preferred embodiments are described in more detail below with reference to the accompanying drawings. It shows:

FIG. 1 a schematic illustration of a platform for code generation and implementation in a hardware environment; and

FIG. 2 schematically shows a flow chart illustrating a method for creating a program code for a tiling group of a neural network;

FIGS. 3a-3b a section from a defined neural network with a tiling group or a calculation procedure for an implemented tiling in two tiling segments; and

FIG. 4 an illustration of the transfer of top and bottom padding from the input tensor to the part input tensors;

FIGS. 5a and 5b show an excerpt from a defined neural network with a tiling group or a calculation procedure for illustrating the consideration of element offsets during the tiling.

### DETAILED DESCRIPTION

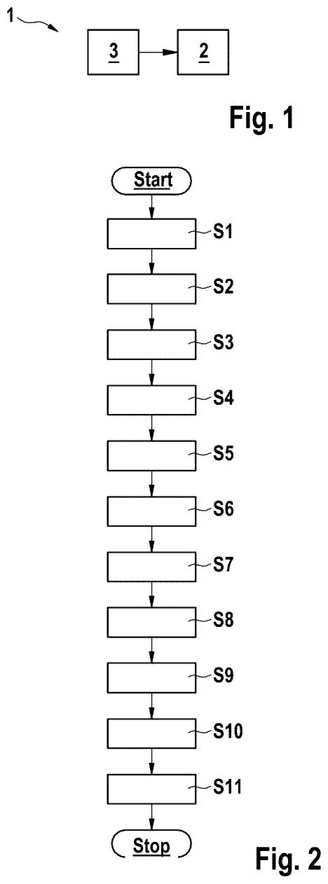

FIG. 1 shows a block diagram of a platform 1 with a code generator for performing code generation for creating a program code and implementing a generated or created program code in a hardware environment 2. For example, the hardware environment corresponds to a control device having a microcontroller, microprocessor, or the like. Code generation is done on a conventional computer 3 or workstation based on the specified configuration of a neural network.

The memory is used to store all of the output data blocks, scratchpad blocks, and weight prefetching blocks for as long as needed to calculate one or more layers. During later layer execution, the same memory areas may be reused to store different storage areas.

The code generator is used to create the program code adapted to a hardware environment 2. Once the code has been generated, it is conventionally transferred to the hardware environment 2, where it is implemented or executed.

In order to be able to operate the program code in hardware environments with reduced memory, tiling may be provided. This tiling must be realized based on the regular definition of the neural network to be implemented in the program code. Tiling is performed for one or more tiling groups.

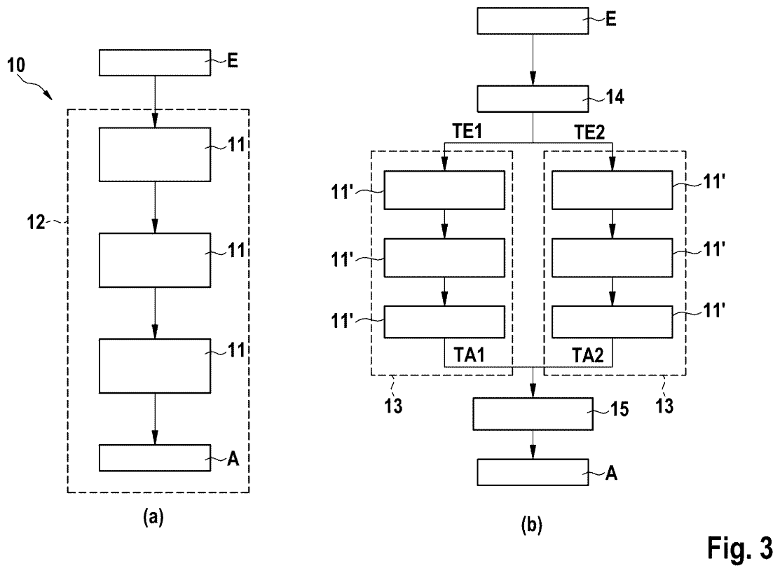

FIG. 3a illustrates a configuration of a neural network 10 according to the specification. The neural network has three serially arranged convolution layers 11 between an input tensor E and an output tensor A that form a tiling group 12 (consecutive layers for calculation using tiling), i.e., a number of serially computed layers for which the code generator is to create a program code that is to compute the convolution layers 11 of the tiling group 12 using tiling. In the case of a tiling factor of 2, FIG. 3b shows the division of the layers of the tiling group 12 into two tiling segments 13, each representing a strand to be calculated separately with convolution layers 11′. The part input tensors TE1, TE2 of the strands 13 are generated by a MultiSlice operator 14 and the sub-output tensors TA1, TA2 are assembled by a concatenation layer 15.

The method described below serves to implement a program code for implementing the calculations of a previously identified tiling group for execution in hardware environment 2.

Not every set of operators forms an allowable tiling group. The following restrictions apply:
1. Each operator in the tiling group must allow tiling. This means that all operators in a tiling group must be one of the following operators: convolution, depthwise convolution, pooling layers, or one of the element-wise operations adding, subtracting, and multiplying, as well as element-wise activation functions such as ReLU and LeakyReLU.
2. All operators must be connected by input-output relationships. Separate sets of operators cannot form a single tiling group.
3. There must be no operator or set of operators that require an input from the tiling group, but also generate an output to the tiling group.

The procedure of the method is described in more detail using the flow chart of FIG. 2.

For this purpose, in step S1, the program code created for calculating a neural network in a hardware environment is provided based on a defined neural network. The defined neural network may, for example, be provided as an onnx file, a keras model, a tensorflow-lite model, or a pytorch model. It can be implemented in a high-level language such as C, a lower representation such as LLVM or inline assembler, or a combination of such representations, e.g. as a C code invoking pre-implemented library functions.

The method is performed from bottom to top. It begins at the TA1, T2 part output tensors of the individual tiling segments 13 and passes through the tiling segments 13 in the reverse of the calculation direction until it reaches the TE1, TE2 part input tensors.

For multiple tiling groups 12 in a network, the algorithm is simply executed multiple times. The method requires a list of operators forming the tiling group and the tiling factor tf as an input.

First, in step S2, a number of code segments are created as copies of the code segments of the calculations of the layers in the tiling group, which corresponds to the number of the tiling factor tf, to form a number of tf subgraphs, i.e. tiling segments.

Then, in step S3, all input tensors that are the input of the tiling group, i.e., part input tensors TE1, TE2 that are needed by the tiling segments of the considered tiling group but are not generated by any of the operators in the tiling group are determined.

For each of these input tensors in the tiling group, a multi-slice operator must be inserted into the original graph that divides the original input tensor into the part input tensors of the individual tiling strands.

Then, in step S4, all the part output tensors that are outputs of the tiling group and are used as either an input from an operator that is not part of the tiling group or the output of the entire neural network are determined.

For each of these output tensors of the tiling group, a concatenation operator must be incorporated in the original graph that recombines the partial output tensors of the tiling strands back into the original output tensor.

In step S5, it is determined which rows of a part output tensor the relevant tiling segment should generate, and then moves upwards layer by layer in the tiling segment, i.e. in the opposite direction to the original calculation direction.

The exact lines r∈[is, ie] with the start index is and the end index ie of a part output tensor with nr total lines, which must calculate the tiling segment with the tiling index it and the tiling factor tf, must be determined so that
1. each line of the output tensor to be computed by the tiling group is calculated in a tiling segment;
2. no line of the output tensor is calculated in multiple tiling segments;
3. the lines of the output tensor to be computed by the tiling group are distributed as evenly as possible among the tiling segments.

Condition 1 must be satisfied to ensure that the full original output tensor can be reconstructed from the results of the tiling group. Condition 2 ensures that no output is computed multiple times, which would result in unnecessary calculations. Condition 3 ensures that the computational load is distributed as evenly as possible among the tiling segments.

The first step to determine the required lines is to calculate the number of lines of the part output tensor for each tiling segment

$$r ( {i}_{t} , {t}_{f} ) = \frac{{n}_{r}}{{t}_{f}} + o ( {i}_{t} , {t}_{f} )$$

which each part segment must calculate, wherein o(i_{f}, t_{f})∈[0,1] if nr is divisible by tf, all the tiling segments will get the same number of lines and o(i_{f}, t_{f})=0. Otherwise, additional lines are assigned to each tiling segment according to o(i_{f}, t_{f}) wherein
for tf=2 and nr odd: o(0, 2)=1 and o(1, 2)=0
For tf=3 and nr % 3=1: o(0, 3)=1, o(1, 2)=0 and o(2, 2)=0
For tf=3 and nr % 3=2: o(0, 3)=1, o(1, 2)=0 and o(2,2)=1

For other tiling factors, o(i_{f}, t_{f}) is determined analogously: First, another line is added for the first tiling segment, then for the last, then for the second, then for the penultimate, etc.

The reason for this type of line arrangement in the outer tiling segments is that by providing padding, the computational load of the outer tiling segments is reduced compared to the inner ones because the rows filled in by the padding are not calculated from a previous layer.

Then, in step S6, for each tiling segment >0, the start index of the row indices is calculated as

$${i}_{s} ( {i}_{t} , {t}_{f} ) = {\sum }_{i = 0}^{{i}_{t} - 1} r ( {i}_{t} , {t}_{f} ) .$$

Of course, for the tiling segment=0, the start index is 0. The final index for all the tiling segments is

$${i}_{e} ( {i}_{t} , {t}_{f} ) = {i}_{s} ( {i}_{t} , {t}_{f} ) + r ( {i}_{t} , {t}_{f} ) - 1.$$

For each operator that generates a part output tensor, in step S7 the required lines of all the part input tensors are calculated. For a start index is and an end index ie of a partial output tensor, the start indices and end indices must be calculated for all partial input tensors required to calculate the indicated output rows. All element-wise operations, such as element-wise addition, multiplication, and subtraction, never use padding so that:

$$is ( ileft ) = is ( iright ) = is ( o )$$

$$and$$

$$ie ( ileft ) = ie ( iright ) = ie ( o )$$

with the left input tensor ileft and the right input tensor iright. Thus, these operators never increase the receptive field, nor do element-wise activation functions.

For convolutions and pooling operators with step size in y-direction sy, kernel size in y-direction ky, top padding pt (padding on top) and bottom padding (padding on bottom) pb is obtained

For the start and end indices is

$${i}_{s} ( i ) = relu ( {i}_{s} ( o ) \cdot {s}_{y} - {p}_{t} )$$

$$and$$

$${i}_{e} ( i ) = min ( {i}_{e} ( o ) \cdot {s}_{y} + {k}_{y} - 1 - {p}_{t} , input\_y - 1 ) .$$

and ie of the required lines of the input tensor. That is to say, all lines i∈[is, ie] of the input tensor are required for the given part output tensor to be calculated.

The formulas for the start and end indices take into account the fact that operators with top and bottom padding pt and pb correspond to an operator without padding, whose input tensor has pt additional lines at the beginning and pb additional lines at the end.

The value pt of the top padding is deducted from the index values, because an operator using top padding does not receive the first pt lines of the input tensor as input but fills them with additional predefined values.

Thus, the number of lines of the top padding is subtracted from both the start index and the end index. If the original operator uses a bottom padding, the last lines of the input tensor are not generated by another operator but are additionally filled in with predetermined values. In this case, the expression in the left argument of the min operator in the formula for ie may take values i≥ input_y. These are not part of the actual input tensor but are generated by the bottom padding. The insertion of the min operator into the expression for ie takes this fact into account.

These two modifications together ensure that correct indices for the input tensors are also calculated for operators with top and bottom padding.

The information about the required lines is assigned to the corresponding part input tensor.

The required padding for each operator can be derived from the calculated information of the part input tensors in step S7.

Tiling a network increases the number of different types of padding that can occur in a network. Tiling a Convolutional Layer with Padding can comprise the following variations:

$$( top , right , bottom , left ) = ( 1 , 1 , 1 , 1 )$$

$$( top , right , bottom , left ) = ( 1 , 1 , 0 , 1 ) ,$$

$$( top , right , bottom , left ) = ( 0 , 1 , 0 , 1 ) ,$$

$$( top , right , bottom , left ) = ( 0 , 1 , 1 , 1 ) .$$

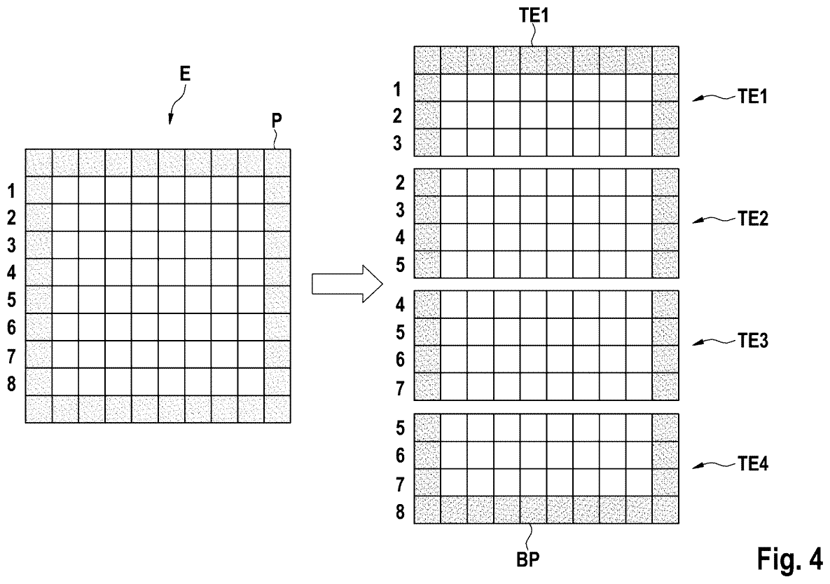

FIG. 4 illustrates partitioning an input tensor E with padding into multiple sub-input tensors TE1, TE2, TE3, TE4. It can be seen that a top and bottom padding (TP, BP) only takes place at the first and last part input tensor, respectively.

It may be that due to the growing receptive field in larger tiling segments, even inner tiling elements at the top or bottom could still require padding. The different paddings in the tiling segments cause the implementations of the copies of the original operator to be slightly different in all the tiling segments.

This is repeated for all input tensors that have collected line information from all operators that use them until all the part input tensors of the tiling segment have the required lines assigned.

In some cases, the network topology is such that an input tensor is consumed by two operators having different receptive fields.

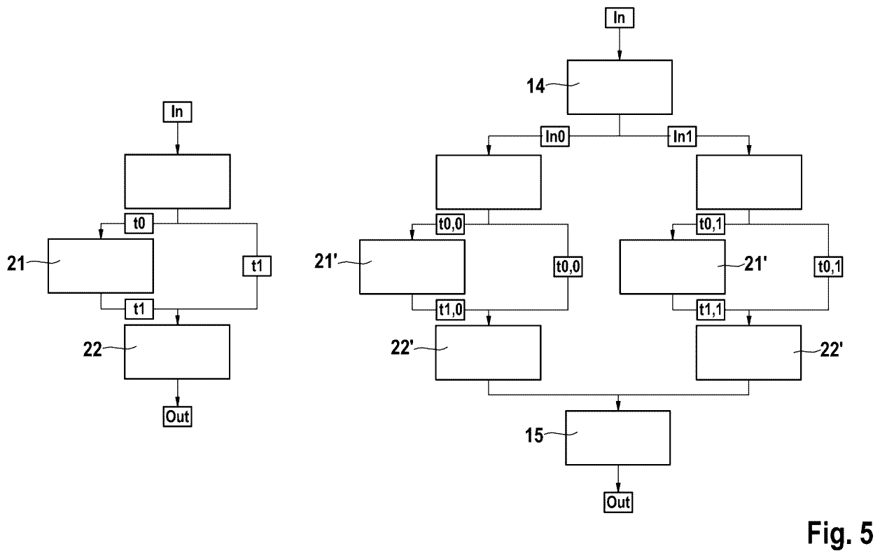

Such a case results in skip connections, for example, as they occur in Resnet architectures, e.g., for the part input tensor to in FIG. 5a. This is used by a convolution layer 21 as a part input tensor, the output tensor t1 of which is added back together with the original tensor to in an add operator 22. FIG. 5b accordingly shows the tiling-enabled network with the tiling-enabled convolution layers 21′ and the add operator 22′.

In addition, it is also possible for the concatenation operators of the part output tensors to use an element offset. This occurs when the part output tensor in the tiling group is reused. In this case, the concatenation operator gathering, which combines the partial output tensors into the original tensor needs to use element offsets because, due to the receptive field of the convolution, which uses to as the input tensor, it must contain more elements for this layer.

An element offset may be either an offset at the start of the particular part output tensor or an offset at the end of the particular part output tensor. If an offset is required at the beginning of the part input tensor, an offset must be introduced into the tensor argument in the function call of the corresponding layer implementation. In C, for example, this may be implemented using pointer arithmetic. If an offset is required at the end of the part input tensor, no change is required. The part input tensor is simply not used up to the last elements.

Now, in step S8, the element offsets are assigned according to the number of lines required for the tensor. If a tensor of two or more operators that have it as an input is assigned a different number of required lines, the required number of lines is the union of all the required lines. However, the consuming operators each use only a subset of this union. It is possible that a certain number of elements are not needed at the beginning of the tensor in some operators, and a certain number of elements are not needed at the end of the tensor in some operators.

If elements are not required at the beginning of the tensor, this can be represented, for example, with a pointer offset in the argument of the C-function representing the corresponding operator.

If elements are not needed at the end of the tensor, no further steps are necessary; the corresponding function simply does not read these elements.

After a code segment has been created for all the tiling segments, in step S9 a code segment for a MultiSlice operator is generated that divides the input tensor of the tiling group into part input tensors using the line index information determined for all the tiling segments.

Further, in step S10, a code segment for the combination/concatenation of the part output tensors in the program code to be created for calculating the output tensor of the tiling group is generated. The corresponding concatenation operator for each part output tensor is created from the line index information. All tiling segments are associated with the MultiSlice and concatenation operators.

Each MultiSlice operator has the corresponding original input tensor of the tiling group as an input, and each concatenation operator has the corresponding original output tensor of the tiling group as an output.

Furthermore, in step S11, the combined tiling segments are inserted into the neural network program code, thereby replacing the tiling group to be subjected to tiling.

In step S12, the program code completed with the tiling segments and the code segments is implemented in hardware environment 2.

Tiling can reduce maximum RAM usage only in certain situations. The neural network must contain a block of layers with a small input tensor and a small output tensor while the intermediate tensors are much larger.

While tiling may not always reduce peak RAM consumption in a hardware environment, it can always be used to provide CNNs on host accelerator systems where the accelerator does not have sufficient memory for some convolutional layers in the neural network. In this case, the method is
1. Find all layers that are too large for the accelerator
2. Create at least one single-layer tiling group for each layer
3. Determine or provide the required tiling factor
4. Perform the tiling

Also in this case, larger tiling strands are often desirable because they can reduce the number of storage copies from the host to the accelerator and back.

What is claimed is:

1. A computer-implemented method for operating a code generator to create a program code for computing a neural network in a hardware environment, comprising:
providing a defined neural network;
identifying at least one tiling group;
creating a tiling code segment for computing the layers of the at least one tiling group using tiling;
creating a program code for computing the defined neural network in the hardware environment, wherein the code segment created for computing the tiling group is implemented in the program code; and
implementing the program code in the hardware environment.

2. The method according to claim 1, wherein the program code is created from a defined program code using a code generator, wherein the defined program code describes a neural network provided in a common definition description as an onnx file, a model stored in keras, a tensorflow-lite model, or an exported pytorch file.

3. The method according to claim 1, wherein the at least one tiling group is formed with a number of serially consecutively computed layers, processes an input tensor and computes an output tensor in the layers, wherein each of the layers of the tiling group corresponds to one of the following operators: a convolution calculation, a depthwise convolution calculation, a pooling layer calculation, and one of the element-wise operations: adding, subtracting, and multiplying.

4. The method according to claim 3, further comprising:
creating a number of tiling segments as copies of the code segments of the calculations of the layers in the at least one tiling group;
determining the part input tensors needed by the tiling segments but not generated by any of the layers in the tiling group and the part output tensors that are outputs of the tiling segments;
determining the lines for each part output tensor, wherein a respective start index and an end index are determined;
determining the lines for each part input tensor, wherein a respective start index and an end index are determined;
creating a code segment for a MultiSlice operator that divides the input tensor of the tiling group into part input tensors using the start indices and end indices and associates it with the respective tiling segment;
creating a code segment for a concatenation operator to combine the part output tensors to the output tensor to be calculated; and
compiling the MultiSlice operator, the calculations of the layers for each of the tiling segments, and the concatenation operator to the code segment.

5. The method according to claim 4, wherein the lines of each part output tensor are determined so that each line of the output tensor to be computed by the tiling group is calculated in a tiling segment, no line of the part output tensor is computed in multiple tiling segments, and the lines of the output tensor to be computed by the tiling group are distributed as evenly as possible among the tiling segments.

6. The method according to claim 4, wherein the lines of the output tensor are distributed among the part output tensors in equal parts, and wherein excess lines are evenly distributed among some of the part output tensors.

7. The method according to claim 4, wherein a padding of the input tensor is considered for determining the lines for each part input tensor.

8. The method according to claim 1, wherein a tiling group comprises only at least one layer, wherein the code segment is provided for execution in an accelerator hardware of the hardware environment, and wherein a required tiling factor for the number of tiling segments is determined such that a memory of the accelerator hardware is sufficient to compute the tiling segments.

9. A code generator for carrying out the method according to claim 1.

10. A computer program product comprising instructions which, when the program is executed by at least one data processing device, cause the data processing device to perform the method according to claim 1.

11. A machine-readable storage medium comprising commands which, when executed by at least one data processing device, cause the data processing device to perform the method according to claim 1.

12. The method according to claim 2, wherein the code generator is an Embedded AI Coder.
